(19) United States
(12) Patent Application Publication
(10) Pub. No.: US 2020/0186885 A1
(43) Pub. Date: Jun. 11, 2020

(54) USER/INTERACTION ASSOCIATION VIA A MEDIA GATEWAY

(71) Applicant: OpenTV, Inc., San Francisco, CA (US)

(72) Inventors: Jean-Rene Menand, Los Altos, CA (US); Debra Hensgen, San Jose, CA (US); Glenn Morten, Bellevue, WA (US)

(21) Appl. No.: 16/572,420

(22) Filed: Sep. 16, 2019

Related U.S. Application Data
(63) Continuation of application No. 14/308,545, filed on Jun. 18, 2014, now abandoned.

(51) Int. Cl. H04N 21/475; H04H 60/45; G06Q 30/02; H04H 60/33; H04N 21/426; H04N 21/258; H04N 21/442; H04N 21/658; H04N 21/4784

(52) U.S. Cl. CPC H04N 21/4753; H04H 60/45; G06Q 30/02; H04H 60/33; H04N 21/4784; H04N 21/25875; H04N 21/44222; H04N 21/25816; H04N 21/6582; H04N 21/42684

(57) ABSTRACT

Methods and systems of associating a user with an interaction via a media gateway are presented. In an example method, a media gateway may identify a user of a user device interacting with the media gateway via a local interface. The media gateway may associate the user with at least one interaction of the user device with the media gateway. The media gateway may also authenticate itself with a server, and provide to the server an indication of the association of the user with the at least one interaction of the user device with the media gateway.

### CLAIM OF PRIORITY

This application is a continuation of U.S. patent application Ser. No. 14/308,545, filed on Jun. 18, 2014, which is incorporated herein by reference in its entirety.

### FIELD

This application relates generally to the field of electronic communications and, in an example embodiment, to associating a user with an interaction via a media gateway.

### BACKGROUND

In some media environments, such as, for example, interactive television applications provided by way of a set-top box and/or media gateway and a connected display device, a user may earn a benefit, such as “points” or some other type of consideration, in response to an activity performed by the user. Such an activity may include, for example, watching a particular item of content (e.g., a television program or an advertisement), engaging in a particular game, or some other interaction between the media gateway or set-top box and the user.

To assign the award to the correct user performing the interaction, the media gateway or set-top box may request the user to enter some kind of identification, such as a user identifier or personal identification number (PIN), into the media gateway or set-top box, such as by way of a remote control or wireless keyboard communicatively coupled with the media gateway or set-top box. In circumstances in which more than one user may interact regularly with the media environment, such as in the typical case of a household with multiple family members, the users may consider the entering of a user identifier or PIN to be at least somewhat onerous. In other examples, a user interacting with the media environment may simply forget to enter the identifying information after another person has engaged with the environment, thus causing the set-top box or media gateway to determine incorrectly the particular user currently interacting with the environment.

### BRIEF DESCRIPTION OF DRAWINGS

Embodiments are illustrated by way of example and not limitation in the figures of the accompanying drawings, in which like references indicate similar elements and in which:

FIG. 1 is a block diagram of an example communication system employable for associating a user of a user device and an interaction using a media gateway:

FIG. 2 is a block diagram of an example media gateway employable in the communication system of FIG. 1:

FIG. 3 is a block diagram of an example server employable in the communication system of FIG. 1;

FIG. 4 is a flow diagram of an example method of associating a user and an interaction via a media gateway;

FIG. 5 is a flow diagram of an example method of identifying a user based on establishing a connection between a user device and a media gateway;

FIG. 6 is a flow diagram of an example method of identifying a user based on a user device interacting with a media gateway;

FIG. 7 is a flow diagram of an example method of performing a user-specific action based on a user and an interaction; and

FIG. 8 is a diagrammatic representation of a machine in the example form of a computer system within which a set of instructions may be executed for causing the machine to perform any one or more of the methodologies discussed herein.

### DETAILED DESCRIPTION

In the following description, for purposes of explanation, numerous specific details are set forth in order to provide a thorough understanding of the embodiments disclosed herein. It will be evident, however, to one skilled in the art that the embodiments may be practiced without these specific details.

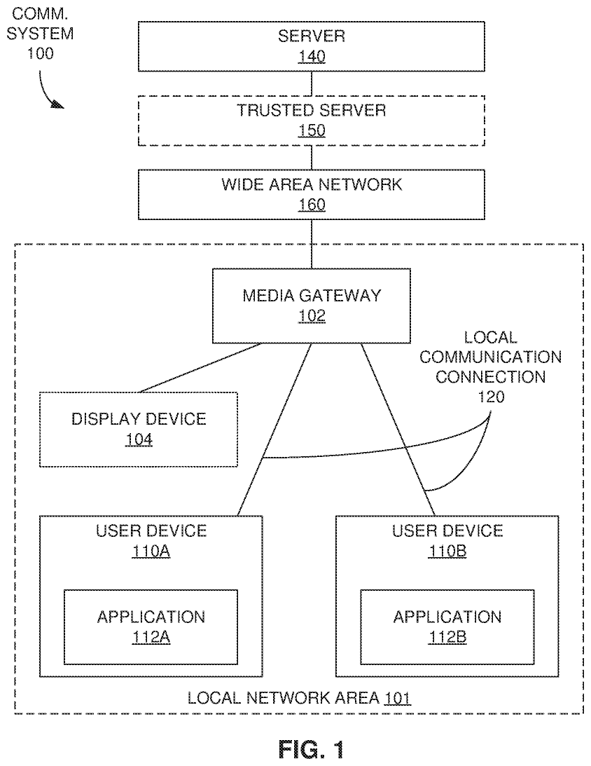

FIG. 1 is a block diagram of an example communication system 100 employ able for associating a user and an interaction via a media gateway. In the system 100, a local network area 101, which may be a home, apartment, small business, restaurant, bar, or other similarly localized area, may include a media gateway 102 that is configured to deliver media content, interactive content, and the like to one or more users located at the local network area 101. In some examples, the media gateway 102 may deliver the content to the user by way of a display device 104, such as a television and/or other device capable of presenting audio, video, or other content to a user. In some examples, the media gateway 102 may be a smart television, computer, or other device capable of presenting content to a user without the use of a separate presentation device. The media gateway 102 may also deliver the content to one or more user devices 110, which are described in greater detail below.

To deliver content, the media gateway 102 may configured as a cable modulator/demodulator (modem), digital subscriber line (DSL) modem, or other gateway for relaying communication traffic between the local network area 101 and one or more servers 140 via a wide area network (WAN) 160 (e.g., the Internet) and possibly one or more trusted servers 150. In one example, the server 140 may be a remote third-party server that provides one or more services by way of the trusted server 150, which may be a server of a service provider, such as a cable television service provider, a satellite television service provider, an Internet service provider (ISP), and so on. In other examples, the server 140 may be communicatively coupled to the media gateway 102 via the WAN 160 without a separate intervening server 150.

In some embodiments, the media gateway 102 may also serve as or include a television set-top box to provide content received by way of satellite antenna, cable connection, terrestrial antenna. Internet connection, and/or other communication connection to a user via the display device 104 (e.g., a television or video monitor). Accordingly, the media gateway 102 may include one or more tuners, a digital video recorder (DVR), and other components often associated with a set-top box.

The media gateway 102, in some examples, may also operate as a local area network (LAN) router (such as an Ethernet router and/or a WiFi® router for routing communication traffic between various communication devices within the local network area 101) and/or a local communication connection device (e.g., a Bluetooth®-enabled device), thus facilitating communication between the media gateway 102 and one or more user devices 110A and 110B (alternatively, user devices 110) located within the local network area 101 by way of wired and/or wireless local communication connections 120. Examples of the user devices 102 include, but are not limited to, desktop, laptop, and tablet computers; gaming systems; smart phones; personal digital assistants (PDAs); printers; and so on.

One or more of the user devices 110A and 110B may include an application 112A and 112B (alternatively, application 112) that may be executed by the user device 110. In some examples discussed hereinafter, the application 112 may facilitate the interaction of the user with the media gateway 102 by, for example, presenting media content and/or interactive content to the user. Such media content may include, for example, television series episodes, movies, sporting events, news programs, audio clips, still images, documents, and so on. The interactive content may include, in some embodiments, interactive shopping programs, interactive gaming programs, news feed programs, stock information programs, and the like. Each of these interactive programs may be executed on the media gateway 102, on the user device 110 (e.g., by way of the application 112), or some combination thereof.

In some examples, the application 112 executing on the user device 110 may provide the media gateway 102 with an identifier for the user and/or the user device 110. Also, in some embodiments, a single application 112 may both facilitate interaction of the user with the media gateway 102 as well as provide the media gateway 102 with the identifier for the user and/or the user device 110, while in other examples, separate applications 112 may perform these functions. Further, the user device 110 may include multiple applications 112, each of which facilitates a different type of interaction between the user and the media gateway 102, and one or more of these applications 112 may provide the media gateway 102 with the identifier for the user and/or the user device 110.

In the embodiments described below, the media gateway 102 may facilitate, in an accurate and secure manner, the identification of a user employing a user device 110 to interact with the media gateway 102, and to supply that identification, along with an indication of the interaction between the user device 110 and the media gateway 102, to at least one server 140, 150. Such identification may allow the server 140, 150 to perform some user-specific or user-related action, possibly including, but not limited to, providing user-specific content to the user, tracking the consumption of content by the user, and providing the user a benefit based on actions or habits of the user.

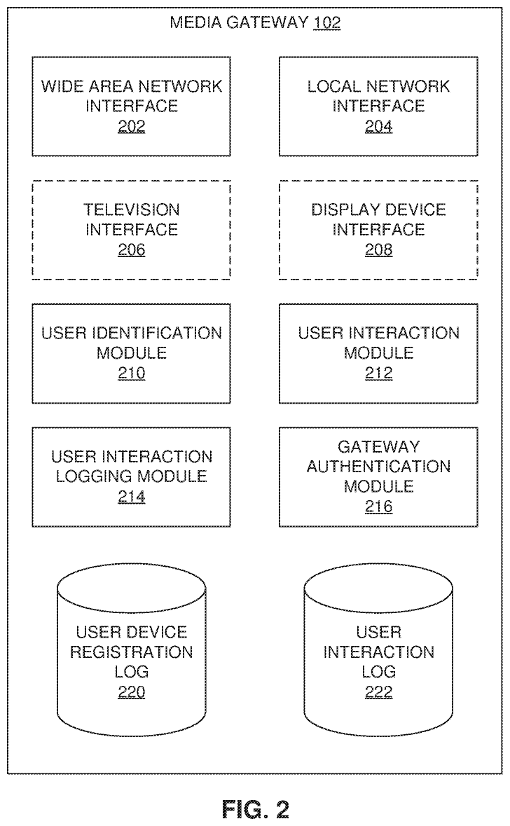

FIG. 2 is a block diagram of an example of the media gateway 102 employed in the communication system 100 of FIG. 1. In this example, the media gateway 102 may include a wide area network (WAN) interface 202, a local network interface 204, a traditional television interface 206, a display device interface 208, a user identification module 210, a user interaction module 212, a user interaction logging module 214, and a gateway authentication module 216. Each of these modules, as well as other modules described herein, may include hardware, software, or some combination thereof for performing the various functions corresponding to the module, as is described more fully below. The media gateway 102 may also include one or more of a user device registration log 220 and a user interaction log 222. Other possible components, such as, for example, a user interface, one or more broadcast channel tuners, a DVR, and so on, as mentioned above, may be included in the media gateway 102, but are not explicitly illustrated in FIG. 2 to simplify the following discussion.

The WAN interface 202 may facilitate communications between the media gateway 102 and the one or more servers 140 and/or the one or more trusted servers 150 of FIG. 1. As discussed in greater detail below, the media gateway 102 may provide the server 140, 150 with information identifying a user of the user devices 110, as well as various interactions of the user with the media gateway 102. The server 140, 150 may then perform some user-specific or user-related action or operation based on the user and associated interaction information, as mentioned above.

The local network interface 204 may be configured to facilitate communication between the media gateway 102 and one or more of the user devices 110 of FIG. 1. Accordingly, the local network interface 204 may be capable of communicating using the local communication connections 120 via any one or more of Ethernet. WiFi®, Bluetooth®, NFC™, RFID, HomePlug®, and other communication networks, connections, or protocols. In some examples, the local network interface 204 may serve as a LAN router, thus operating as a communication node through which the user devices 110 may communicate within the local network area 101. In other examples, the media gateway 102 may be communicatively coupled with an external LAN router to facilitate communication among the media gateway 102 and the user devices 110.

The traditional television interface 206, if provided, may be configured to received media content, interactive program content, and the like via one or more of a satellite antenna, a cable connection, a terrestrial antenna, and/or other broadcast communication connection for presentation to a user, such as via the display device interface 208. Consequently, as discussed above, the media gateway 102 may include one or more tuners, a DVR, and other components often associated with a set-top box. Such components are not explicitly shown in FIG. 2 or described in greater detail herein.

The display device interface 208 may be configured to generate output signals compatible with one or more display devices 104, such as, for example, a television, a video monitor, and/or so on to present media content, interactive content, and the like to the user. For example, the output signal may be compatible for transmission to the display device 104 over a coaxial cable, a composite video connection, a component video connection, an HDMI (High-Definition Multimedia Interface) connection, or any other connection capable of forwarding the content to the display device 104 for viewing by the user. In other examples, the media gateway 102 may include the display device 104, thus possibly resulting in the display device interface 208 not being incorporated in the media gateway 102, or not being accessible externally to the media gateway 102.

The user identification module 210 may be configured to determine the identity of a user associated with a particular user device 110 that is communicatively coupled with the media gateway 102. In an embodiment, the user identification module 210 may be configured to cause the user device 110 to register with the media gateway 102 prior to allowing the user device 110 to communicate via, or otherwise interact with, the media gateway 102. During the registration, the user identification module 210 may receive information from the user device 110 indicating an identifier for the user device 110 (e.g., a media access control (MAC) address) as well as an identifier for the user of the user device 110 (e.g., a name, a username, an email address, or the like). The user identification module 210 may also store one or both of the identifiers for the user device 110 and the user in association with each other in the user device registration log 220. Thereafter, when the user device 110 establishes a communication connection 120 with the media gateway 102, the media gateway 102 may detect the identifier for the user device 110 and thus associate the appropriate user to the user device 110 via the user device registration log 220.

In some embodiments, the user identification module 210 may receive an identifier for the user in the course of the user device 110 executing the application 112, which may provide the user identifier to the media gateway 102. Further, in some examples, the application 112 may explicitly request the user to enter some kind of identifying information or code (e.g., username, password, and/or the like) to ensure that the application 112 explicitly determines the identity of the user. The user identification module 210 may perform other operations in addition to, or in lieu of, the operations described above to discover a particular user associated with a specific user device 110.

In some examples, the user identification module 210 may also identify users of remote user devices (not shown in FIG. 1) that interact with the media gateway 102 via the WAN 160 and the WAN interface 202. In one embodiment, a user may employ a Slingbox® or similar device to interact with the media gateway 102 via the WAN 160 to view media content on the remote user device that is normally provided via the display device 104. In such situations, the remote user device may log in to the media gateway 102 via username, password, and/or some other mechanism by which the user identification module 210 may identify the user prior to the remote user device accessing the media content. Moreover, the user identification module 210 may distinguish between local user devices interacting with the media gateway 102 via the local network interface 204 and those interacting with the media gateway 102 via the WAN interface 202, by way of which interface 202, 204 is being employed for interaction with the media gateway 102, as is described in greater detail below.

The user interaction module 212 may be configured to facilitate one or more types of interactions between the media gateway 102 and one or more user devices 110. Such interactions may include, for example, relaying media content (e.g., video content, still image content, audio content, documents, web-based content, and so on) received at the media gateway 102 via the WAN 160 using the WAN interface 202, and/or via the traditional television interface 206. These types of interactions may also be represented by the user's selection of a particular broadcast channel for viewing or recording, as well as other interactions between the user via the user device 110 and/or directly with the media gateway 102 or the display device 104, such as by way of a remote control unit.

The user interactions may also include, for example, providing an interactive program for use by the user, as well as the user's actual use of the interactive program. For example, the interactions may include the reception of user commands for the interactive program by way of a remote control unit associated with the media gateway 102 and/or the display device 104, the user device 110 associated with the user, and other components, as well as the output of responses to the user commands by way of the display device 104, the user device 110, and/or other devices.

Moreover, the user interactions may include, for example, any content received, commands provided, output generated, and/or other interactions between the media gateway 102 and the user that involve content and/or other information exchanged between the server 140 or other communication nodes via the WAN 160 using the wide area network interface 202. In using the media gateway 102 to access the WAN 160, the user device 110 may engage in interactions such as downloading web pages, documents, audio content, video content, and so forth; accessing shopping web sites; interacting with social media; taking part in surveys; and many others.

In yet other examples, the user interaction module 212 may also facilitate interactions between the media gateway 102 and a remote user device (not shown in FIG. 1) via the WAN interface 202. In one embodiment, a user may employ a Slingbox® or similar device to interact with the media gateway 102 via the WAN 160, as mentioned above. Such interactions may or may not be treated equally compared to interactions that occur via the local network interface 204. For example, the user interaction module 212 may be configured to identify and track the interactions of the user devices 110 located within the local area network 101, and ignore interactions of user devices located externally to the local area network 101. Such embodiments may help prevent spoofing of user interactions instigated by user devices not located within the local network area 101.

In conjunction with the user interaction module 212, the user interaction logging module 214 may be configured to log to the user interaction log 222 interactions undertaken by one or more users with the media gateway 102 that employ the WAN interface 202 and/or the traditional television interface 206. For example, the user interaction logging module 214 may record each interaction of interest, including the particular interaction involved and a time at which, or a time period during which, the interaction occurred, and an identifier for the particular user and/or user device 110 engaging in the interaction. In one example, the user interaction logging module 214 may receive this information from the user interaction module 212 and store some version of that information to the user interaction log 222. Further, the user interaction logging module 214 may store all of the information relating to each interaction as a data object, or may use some other storage strategy to relate each interaction with its particular user or user device 110.

In some examples, the user interaction logging module 214 may filter the information received from the user interaction module 212 so that information associated with less than all of the interactions taking place are recorded at the user interaction log 222. For example, the user interaction logging module 214 may distinguish between user devices 110 interacting with the media gateway 102 via the local network interface 204 and those that interact with the media gateway 102 via the WAN interface 202 by filtering or ignoring those interactions occurring via the WAN interface 202, thus resulting in only those interactions facilitated via the local network interface 204 being logged to the user interaction log 222. In other examples, interactions that occur via the local network interface 204 and the WAN interface 202 may both be logged to the user interaction log 22, and thus be treated equally for purposes of reporting such interactions to the server 140, 150.

The gateway authentication module 216 may be configured to authenticate the media gateway 102 with one or more servers 140 and/or trusted servers 150, thus providing the servers 140 and/or trusted servers 150 with a measure of security that the media gateway 102 is a trusted source of information. In one example, the gateway authentication module 216 may transmit a digital certificate or other secure form of identification via the WAN interface 202 over the WAN 160 to a server 140, 150 to authenticate the media gateway 102 with the server 140, 150.

Consequently, by identifying a user interacting with the media gateway 102 via the user identification module 210, and verifying or authenticating the media gateway 102 with a server 140, 150 of interest, the server 140, 150 may receive accurate, verified information regarding user and user device 110 interactions with the media gateway 102. The server 140, 150 may then use that information for various purposes, as mentioned above.

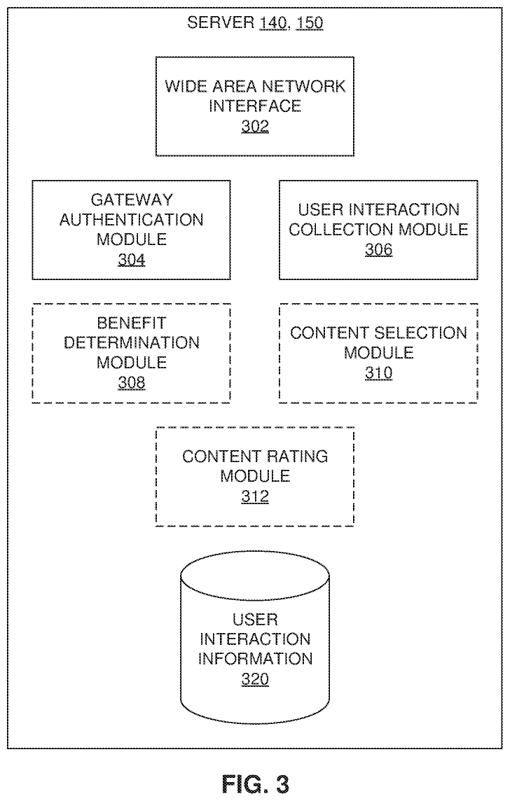

FIG. 3 is a block diagram of an example of the server 140, 150 employable in the communication system 100 of FIG. 1. In the example of FIG. 3, the server 140, 150 may include a wide area network (WAN) interface 302, a gateway authentication module 304, a user interaction collection module 306, a benefit determination module 308, a content selection module 310, and/or a content rating module 312. The server 140, 150 may also include user interaction information 320 received from the media gateway 102 of FIG. 2. In particular embodiments, one or more of the modules depicted in FIG. 2 may not be included in the server 140, 150. Also, other components may be included in the server 140, 150, but are not explicitly illustrated in FIG. 3 to simplify the following discussion.

Similar to the WAN interface 202 of the media gateway 102 of FIG. 2, the WAN interface 302 of FIG. 3 may be configured to facilitate communications between the server 140, 150 and the media gateway 102. As mentioned above, the server 140, 150 may receive from the media gateway 102 information identifying a user of the user devices 110, as well as various interactions of the user with the media gateway 102. The server 140, 150 may then perform some user-specific or user-related action or operation based on the user and associated interaction information.

Operating in some examples as a counterpart to the gateway authentication module 216 of the media gateway 102 of FIG. 2, the gateway authentication module 304 may be configured to authenticate the media gateway 102 so that any user interaction information received from the media gateway 102 may be trusted. In one example, the gateway authentication module 304 may receive a digital certificate or other secure form of identification of the media gateway 102 from the media gateway 102 over the WAN 160 via the WAN interface 302 so that the server 140, 150 may authenticate the server 140, 150.

The user interaction collection module 306 may be configured to receive information indicating interactions undertaken by one or more users with the media gateway 102. For example, the user interaction information may include information regarding each interaction of interest, including the particular interaction involved and a time at which, or a time period during which, the interaction occurred, and an identifier for the particular user and/or user device 110 engaging in the interaction with the media gateway 102. In one example, the user interaction information received at the server 140, 150 may have been stored at the user interaction log 222 of the media gateway 102 prior to the media gateway 102 transmitting that information to the server 140, 150 via the WAN 160. Further, the user interaction collection module 306 may store at least some version of that information as the user interaction information 320 of the server 140, 150. Further, the user interaction collection module 306 may store all of the information relating to each interaction as a data object, or may use some other storage strategy to relate each interaction with its particular user or user device 110. In some examples, the user interaction collection module 306 may filter the information received from the media gateway 102 so that information associated with less than all of the interactions taking place is recorded as the user interaction information 320.

Based on the user interaction information 320, the server 140, 150 may perform one or more user-specific operations or tasks. Examples of modules that may perform such operations at the server 140, 150 include, but are not limited to, the benefit determination module 308, the content selection module 310, and the content rating module 312. In one embodiment, the benefit determination module 308 may assign or reward a user of a user device 110 with one or more benefits in terms of cash, products, loyalty credit (e.g., loyalty “points”), and/or the like based on at least one interaction between the user via a user device 110 and the media gateway 102. For example, if the user has accessed or received content provided by a particular content provider, has purchased one or more products from a particular merchant, or has engaged a particular provider in some other valuable way, as reflected in the user interaction information 320 received from the media gateway 102, the server 140, 150 may award one or more benefits to the user.

The content selection module 310 may be configured to deliver, advertise, or perform some other action involving media content (e.g., audio content, audio/visual content, still image content, graphical content, textual content, and so on) to a user device 110 of a user based on at least one interaction between the user via a user device 110 and the media gateway 102. For instance, if the user has been accessing audio content of a particular musician, perusing a website representative of that musician, engaging in social media involving the musician, or so on via the media gateway 102, and such interactions are indicated in the user interaction information 320, the server 140, 150 may select alternative content of the musician, content created by another musician of a similar style as that of the first musician, or some other content of potential interest to the user. The server 140, 150 may advertise or deliver the selected content to the user, possibly by way of the media gateway 102 to one or more user devices 110 associated with the user. In one example, the selected content, or advertisement therefor, may be delivered to at least one user device 110 which was not involved in the interaction of the user with the media gateway 102.

The content rating module 312 may be configured to provide rating information for one or more types of media content (e.g., musical pieces, television programs, motion pictures, and so on) involving a plurality of users interacting with multiple media gateways 102 coupled with the server 140, 150, and possibly with other servers. More specifically, the server 140, 150 may receive user interaction information 320 that indicates the particular items of media content that each user interacting with the media gateways 102 views, purchases, downloads, or otherwise consumes. The server 140, 150 may then process the user interaction information 320 to generate rating information that indicates, for example, the relative popularity of at least some of the content items.

In some embodiments, the server 140, 150 may access data other than that available in the user interaction information 320 to perform one or more of the operations described above. With respect to the content rating module 312, for example, the server 140, 150 may access demographic information associated with the users of the media gateways 102, geographic information indicating the locations of the media gateways 102, and so forth to provide additional context to the user interaction information 320. Based on this additional context, the server 140, 150 may generate more specific rating information as it relates to age groups, geographic areas, and so on, which may be of significant benefit to content providers, content distributors, and advertisers.

Other examples of additional information that the server 140, 150 may take into account when processing the user interaction information 320 may include information that assists the server 140, 150 in interpreting the user interaction information 320. For example, the content rating module 312, in rating television programs, may access television program scheduling information that indicates the particular geographical areas, days, times, and broadcast channels over which specific programs may be broadcast. Consequently, if the user interaction information 320 provides a particular broadcast channel and time at which a user was viewing content via the media gateway 102, the server 140, 150 may determine the particular program viewed by the user. Other examples of supplementing the user interaction information 320 with additional information to perform one or more operations or tasks within the server 140, 150 are also possible.

Moreover, while FIG. 3 depicts three specific modules (e.g., the benefit determination module 308, the content selection module 310, and the content rating module 312) capable of performing operations based on the user interaction information 320, such modules are exemplary in nature, and many other types of modules that are capable of performing operations for the benefit of users, content providers, product manufacturers and distributors, and other individuals or entities, are also possible.

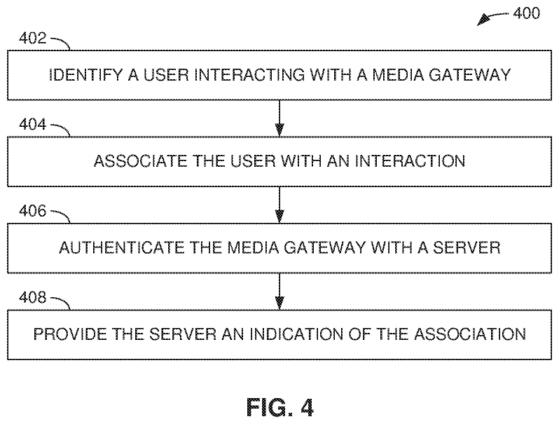

FIG. 4 is a flow diagram of an example method 400 of associating a user and an interaction via a media gateway. In the following examples, the media gateway 102 of FIG. 2, including the various components provided therein, is presumed to perform the various operations of the method 400. However, other media gateway devices or components not specifically described herein may perform the operations of the method 400 in other embodiments.

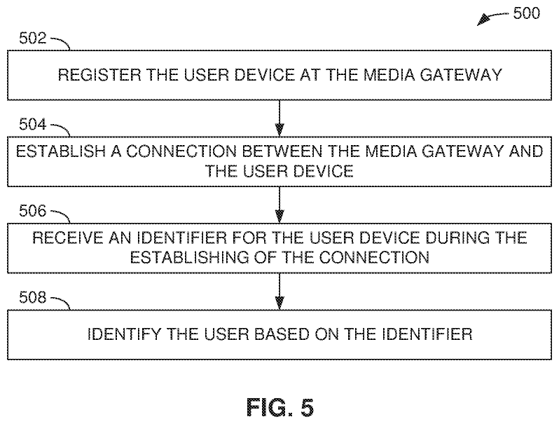

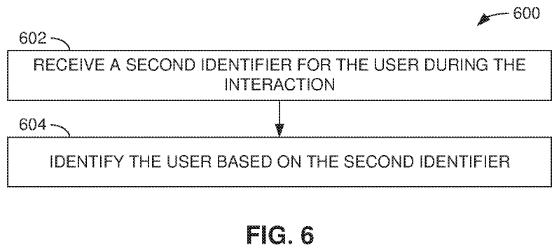

In the method 400, a user of a user device 110 interacting with the media gateway 102 is identified (operation 402). Examples of how the media gateway 102 may identify the user are discussed below in conjunction with FIGS. 5 and 6. The media gateway 102 may associate the user with at least one interaction occurring between the user device 110 of the user and the media gateway 102 (operation 404). In addition, the media gateway 102 may authenticate itself with a server 140, 150 (operation 406). The media gateway 102 may then provide the server 140, 150 with an indication of the association of the user with the interaction (operation 408). As explained above, that indication, possibly along with indications of other interactions of the user with the media gateway 102, as well as interactions of other users with the same media gateway 102 and other media gateways 102 located in other local network areas 101, may be utilized by the server 140, 150 to perform any of a number of different operations or tasks, such as, for example, providing benefits to users, selecting content for users, rating content consumed or accessed by the users, and so on.

While the operations 402 through 408 of FIG. 4 (as well as the operations of other methods illustrated herein) are shown as occurring in a specific order, other orders of operation, including concurrent execution of two or more operations, are also possible. For example, at least operations 402 and 404 may occur periodically, continually, or in some other repetitive manner, possibly in a parallel, simultaneous, or concurrent fashion, as one or more users interact with the media gateway 102 to access media content or other information; provide input to, and receive output from, a television interactive application; and the like. Accordingly, in some examples, multiple users may be viewing the same media content provided via the media gateway 102 and the display device 104. The user device 110 for each of the users may, at that time, be interacting with the media gateway 102 as well, thus causing the media gateway 102 to perform the method 400 for each user present, resulting in an indication of the association of each user with the interaction (e.g., the user viewing the content on the display device 104) to the server 140, 150. In response, the server 140, 150 may then perform a user-specific or user-related action that is associated with each of the users, such as, for example, providing a benefit of some sort to each of the users.

FIG. 5 is a flow diagram of an example method 500 of identifying a user based on establishing a connection between a user device 110 associated with the user and a media gateway 102. In the method 500, a user device 110 may be registered at the media gateway 102 (operation 502). In one example, such a registration may involve reception of some identifier of the user device 110 (e.g., a MAC address) and an identifier of the user (e.g., a username and/or password) such that the media gateway 102 may associate the two identifiers with each other. The media gateway 102 may also register other user devices 110 associated with the same user, as well as user devices of other users.

Also in the method 500, a communication connection 120 may be established between the media gateway 102 and the user device 110 (operation 504). In one example, the communication connection 120 may be established in response to the user device 110 coming within a communication range, such as a WiFi® or Bluetooth® communication range, of the media gateway 102, thus causing a wireless communication connection 120 between the media gateway 102 and the user device 110 to be established. In another example, the user device 110 may be connected to the media gateway 102 via an Ethernet cable or other wired structure, thus causing a wired communication connection 120 to be established.

During the establishment of the connection, or shortly thereafter, the media gateway 102 may receive an identifier of the user device 110 (operation 506), such as the MAC address of the user device 110. Based on the previous registration of the user device 110, the media gateway 102 may determine the identifier of the user that is associated with the received identifier of the user device 110 (operation 508). Thus, as a result of the method 500, the media gateway 102 may attribute interactions of the user device 110 with the media gateway 102 over the established connection to the user associated with the user device 110.

Beyond the establishment of the communication, FIG. 6 is a flow diagram of an example method 600 of identifying a user based on the user device 110 interacting with the media gateway 102. In the method 600, the media gateway 102 may receive a second identifier for the user during the interaction of the user device 110 with the media gateway 102 (operation 602). This second user identifier, which may or may not be the same as the first user identifier received in conjunction with the registration of the user device 110 with the media gateway 102, may also be used at the media gateway 102 to identify the user (operation 604).

In one example, the user may initiate execution of an application 112 (e.g., a web browser, a music player, a video player, or the like) on the user device 110 that interacts with the media gateway 102 to access content, exchange data with the server 140, 150, and/or perform other operations. In response to the user initiating execution of the application 112, the application 112 may transmit a user identifier for the user (e.g., the second user identifier) to the media gateway 102.

In some embodiments, the user device 110, such as a computer, gaming system, or tablet device, may be utilized by more than one user located at the local network area 101. In those embodiments, the user may sign into the user device 110, or to the application 112, by way of a code, such as a username and/or password, to identify the user with the user device 110. That user identifier, or some indication thereof, may be transferred to the media gateway 102 to specifically identify the user from among the potential users of the user device 110 and thus associate that user with interactions of the application 112 with the media gateway 102.

In some embodiments, the application 112 may request input from the user that indicates the user is viewing the display device 104 coupled with the media gateway 102. For example, the application 112 may request the user to answer a question or otherwise describe or indicate content that is currently being displayed on the display device 104. A correct answer from the user regarding the content being displayed on the display device 104 may serve as a verification that the user is viewing the display device 104, and is thus identified as the user that is currently interacting with the media gateway 102. Conversely, an incorrect answer may indicate that the user is not viewing the display device 104, and thus may not be a user that is currently interacting with the media gateway 102 in examples in which the interaction involves viewing of the display device 104.

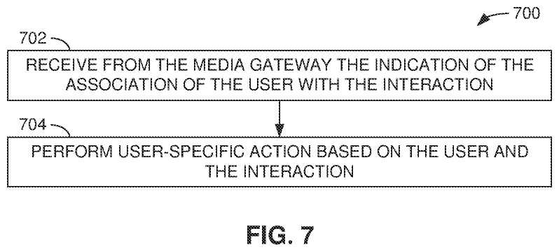

FIG. 7 is a flow diagram of an example method 700 of performing a user-specific or user-related action based on a user and a corresponding interaction. As discussed above, the server 140, 150 may be configured to receive from the media gateway 102 an indication of an association of the user with the interaction (operation 702). The server 140, 150 may receive such information for multiple interactions regarding a particular user interacting with the media gateway 102, as well as corresponding information for other users interacting with the same media gateway 102. In yet other examples, the server 140, 150 may receive this interaction information from a number of different media gateways 102 involving users located at different local network areas 101. Based on the received user and interaction information, the server 140, 150 may then perform user-specific or user-related actions or operations based on that information (operation 704). As mentioned above, examples of such actions may include those that primarily aid the user, a content provider or distributor, an advertiser, or the like, such as, for example, the providing of user benefits or awards, the selection of media content or advertising, the rating of media content, and so on.

In at least some of the embodiments described above, a media gateway may facilitate accurate and secure identification of users and their interactions with the media gateway, such as media content access, use of applications (e.g., television interactive applications, smartphone/tablet applications, and so on), and more. Further, the media gateway may be securely authenticated with one or more servers that may be configured to receive that information in order to perform various functions that depend upon such interaction information that may benefit any of number of parties or entities, including the users themselves.

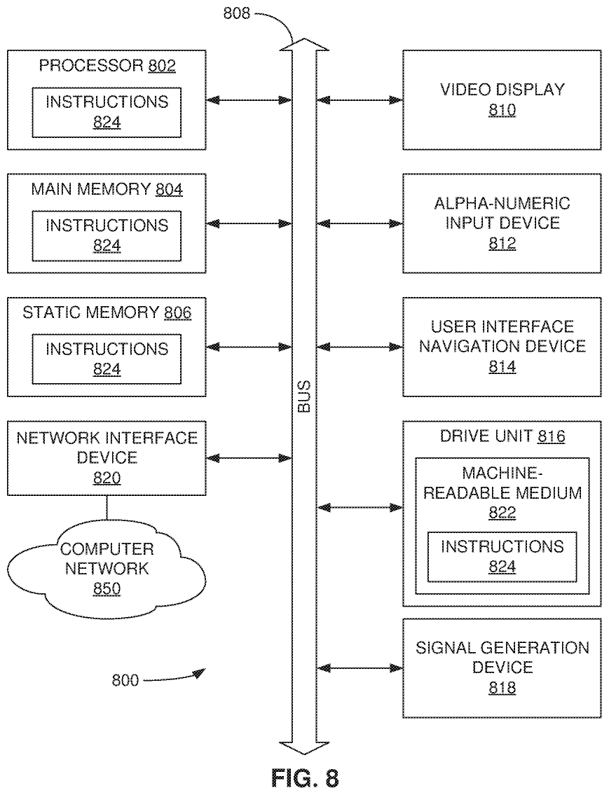

FIG. 8 illustrates a diagrammatic representation of a machine in the example form of a computer system 800 within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer, a tablet computer, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806 which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions and data structures (e.g., instructions 824) embodying or utilized by any one or more of the methodologies or functions described herein. The instructions 824 may also reside, completely or at least partially, within the main memory 804, the static memory 806, and/or within the processor 802 during execution thereof by the computer system 800, the main memory 804, the static memory 806, and the processor 802 also constituting machine-readable media.

The instructions 824 may further be transmitted or received over a network 850 via the network interface device 820 utilizing any one of a number of well-known transfer protocols (e.g., HyperText Transfer Protocol (HTTP)).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions 824. The term “machine-readable medium” shall also be taken to include any medium that is capable of storing, encoding or carrying a set of instructions 824 for execution by the machine and that cause the machine to perform any one or more of the methodologies of the present inventive subject matter, or that is capable of storing, encoding or carrying data structures utilized by or associated with such a set of instructions 824. The term “machine-readable medium” shall accordingly be taken to include, but not be limited to, solid-state memories, and optical and magnetic media.

Throughout this specification, plural instances may implement components, operations, or structures described as a single instance. Although individual operations of one or more methods are illustrated and described as separate operations, one or more of the individual operations may be performed concurrently, and the operations may be performed in an order other than that illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application-specific integrated circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The Abstract of the Disclosure is provided to comply with 37 C.F.R. § 1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments include more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although embodiments of the present disclosure have been described with reference to specific example embodiments, it will be evident that various modifications and changes may be made to these embodiments without departing from the broader scope of these embodiments. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. (canceled)

2. A method comprising:
monitoring, by a network device, user interactions of one or more user devices on one or more networks;
identifying, by the network device, a user device of the one or more user devices;
filtering, by the network device, one or more user interactions of the user interactions of the user device on the one or more networks;
authenticating, by the network device, the network device with one or more servers;
determining, by the network device, whether the one or more user interactions filtered for the user device is to be ignored; and
based on the determining whether the one or more user interactions is to be ignored, providing, by the network device, to a server of the one or more servers, an indication of the one or more user interactions, the indication enabling the server to perform an operation based on the one or more user interactions.

3. The method of claim 2, wherein the network device is a set-top box, a media gateway, or a router.

4. The method of claim 2, wherein the one or more user interactions comprise a relaying of data from the network device to the user device.

5. The method of claim 2, wherein the one or more user interactions comprise providing an interactive program.

6. The method of claim 2, wherein the one or more user interactions comprise receiving a user command.

7. The method of claim 2, wherein the one or more user interactions comprise accessing a web site.

8. The method of claim 2, wherein the one or more user interactions comprise interacting with social media.

9. The method of claim 2, wherein the user device is a gaming system, a phone, or a peripheral device.

10. The method of claim 2, wherein the one or more networks comprise a local area network.

11. The method of claim 2, wherein the one or more networks comprise a wide area network.

12. The method of claim 2, wherein the filtering of the one or more user interactions comprising recording less than all of the one or more user interactions in a user interaction log.

13. The method of claim 2, wherein the determining whether the one or more user interactions filtered for the user device is to be ignored is based on the one or more networks of the one or more user interactions.

14. The method of claim 2, wherein the determining whether the one or more user interactions filtered for the user device is to be ignored is based on whether the user device is local or remote.

15. The method of claim 2, wherein the authenticating of the network device with the one or more servers comprises transmitting a secure form of identification to the one or more servers.

16. The method of claim 2, wherein the providing of the indication of the one or more user interactions comprises providing an indication of an association between a user and the one or more user interactions.

17. The method of claim 2, wherein the enabling of the server to perform the operation based on the one or more user interactions comprises enabling the server to track a consumption of content.

18. The method of claim 2, wherein the enabling of the server to perform the operation based on the one or more user interactions comprises enabling the server to provide content or a benefit based on the one or more user interactions.

19. A network device comprising:
one or more processors; and
a memory that stores instructions that, when executed by the one or more processors, cause the network device to perform operations comprising:
monitoring user interactions of one or more user devices on one or more networks;
identifying a user device of the one or more user devices;
filtering one or more user interactions of the user interactions of the user device on the one or more networks;
authenticating the network device with one or more servers;
determining whether the one or more user interactions filtered for the user device is to be ignored; and
based on the determining whether the one or more user interactions is to be ignored, providing to a server of the one or more servers, an indication of the one or more user interactions, the indication enabling the server to perform an operation based on the one or more user interactions.

20. The network device of claim 19, wherein the network device is a set-top box, a media gateway, or a router.

21. A non-transitory machine-readable medium that stores instructions that, when executed by one or more processors, cause the one or more processors to perform operations comprising:
monitoring user interactions of one or more user devices on one or more networks;
identifying a user device of the one or more user devices;
filtering one or more user interactions of the user interactions of the user device on the one or more networks;
authenticating with one or more servers;
determining whether the one or more user interactions filtered for the user device is to be ignored; and
based on the determining whether the one or more user interactions is to be ignored, providing to a server of the one or more servers, an indication of the one or more user interactions, the indication enabling the server to perform an operation based on the one or more user interactions.
